(19) United States
(12) Patent Application Publication
(10) Pub. No.: US 2024/0403131 A1
(43) Pub. Date: Dec. 5, 2024

(54) DEVICE AND METHOD FOR SCALING MICROSERVICES

(71) Applicant: Telefonaktiebolaget LM Ericsson (PUBL), Stockholm (SE)

(72) Inventors: Johan Eker, LUND (SE); Albin Heimerson, Lund (SE); Karl-Erik Årzén, Malmö (SE)

(21) Appl. No.: 18/695,232

(22) PCT Filed: Sep. 27, 2021
(86) PCT No.: PCT/SE2021/050942

§ 371 Date: Mar. 25, 2024

(51) Int. Cl. G06F 9/50; H04L 41/16

(52) U.S. Cl. CPC G06F 9/5061; G06F 9/505; H04L 41/16

(57) ABSTRACT

A method and a device for scaling microservices in a service mesh using reinforcement learning with a feedback signal. The reinforcement learning model uses information representing an input workload of a microservice chain and current and historical resource allocations of the service mesh, a reward, and the feedback signal to obtain an optimized resource allocation for the workload as an output of the RL model.

### TECHNICAL FIELD

The invention relates to a device and a method for scaling microservices in a service mesh, and corresponding computer program and computer program product.

### BACKGROUND

Microservices are a cloud native architectural approach which allows an application to be separated into loosely coupled and independently deployable smaller parts. To serve a single user request or workload, a microservice-based application may call on many microservices to compose its response.

Cloud computing offers the possibility to auto-scale resources used by microservices to handle increasing or decreasing workloads. Major cloud providers as well as solutions based on OpenStack and Kubernetes, provide extensive application programming interfaces APIs to expand or retract services resources based on metrics, such as latency, CPU utilization, etc.

The cloud scaling problem can be divided into four categories according to BENIFA J B, DEJEY D. Rlpas: Reinforcement learning-based proactive auto-scaler for resource provisioning in cloud environment. Mobile Networks and Applications. 2019 August; 24(4):1348-63: (i) threshold based rules, wherein resources are allocated and freed based on utilization levels, latency limits, etc. in a reactive way; (ii) queuing theory, wherein modeling of the workload and needed service is based on queues; (iii) control theory, wherein proportional-integral-derivative, PID, controller as well as more advanced techniques such as model predictive control, MPC, are used; (iv) machine learning, wherein a predominant machine learning technology used for cloud resource scheduling is reinforcement learning.

Current auto-scaling approaches scale resources locally in each microservice, resulting in low performance, e.g., long response time with high resource allocation. To better understand the problem, FIG. 1a shows an example scenario of a microservice-based application. FIG. 1a shows two call graphs, i.e., a chain of microservices used for processing jobs of a workload initiated by the user: call graph 1 is composed of four microservices (101a, 101b, 101c, 101e connected by a full line in the figure), and call graph 2 is composed of three microservices (101a, 101d, and 101e connected by a dashed line in the figure). Call graphs are typically unknown and data dependent. A sudden increase of the workload along call graph 2 would require the corresponding microservices 101a, 101d, and 101e to scale out. However, given that the control loops are local, there will be a time delay before the increase in traffic is handled in the last microservice of call graph 2, i.e., 101e.

### SUMMARY

An object of the invention is to improve auto-scaling for cloud computing, in particular microservice-based applications.

To achieve said object, according to a first aspect of the present invention there is provided a method for scaling microservices in a service mesh. The method of this first aspect comprises obtaining information representing a workload of a microservice chain, wherein the workload comprises at least one job, and obtaining information representing current and historical resource allocations of the service mesh. The method also comprises determining a reward, wherein the reward is indicative of completed jobs and allocated resources of the service mesh, and producing a feedback signal, wherein the feedback signal is indicative of a delay for increasing the resource allocation of the service mesh. The method further comprises running a Reinforcement Learning, RL, model on the information representing the workload, current and historical resource allocations, reward, and feedback signal, and obtaining a further resource allocation for the workload as an output of the RL model. This provides benefits of improved responsiveness, faster scaling compared to local auto-scalers, and minimized allocated resources.

According to a second aspect of the present invention there is provided a device for scaling microservices in a service mesh. The device comprises a processor and a memory, the memory having stored thereon instructions executable by the processor. The instructions, when executed by the processor, cause the device to obtain information representing a workload of a microservice chain, wherein the workload comprises at least one job, and obtain information representing current and historical resource allocations of the service mesh. The device is also operative to determine a reward, wherein the reward is a function of completed jobs and allocated resources of the service mesh, and produce a feedback signal, wherein the feedback signal is based on a delay for increasing the resource allocation of the service mesh. The device is further operative to run a Reinforcement Learning, RL, model on the information representing the workload, current and historical resource allocations, reward, and feedback signal, and obtain a further resource allocation for the workload as an output of the RL model.

According to a third aspect of the present invention there is provided a computer program comprising instructions which, when run in a processing unit on a device, cause the device to obtain information representing a workload of a microservice chain, wherein the workload comprises at least one job; obtain information representing current and historical resource allocations of the service mesh; determine a reward, wherein the reward is a function of completed jobs and allocated resources of the service mesh; produce a feedback signal, wherein the feedback signal is based on a delay for increasing the resource allocation of the service mesh; run a Reinforcement Learning, RL, model on the information representing workload, current and historical resource allocations, reward, and feedback signal; obtain a further resource allocation for the workload as an output of the RL model.

According to a fourth aspect of the present invention there is provided a computer program product comprising a computer readable storage medium on which a computer program, as mentioned above, is stored.

In an embodiment, a resource allocation of the service mesh comprises a queue of jobs for at least one microservice and a number of instances for running the at least one microservice.

In an embodiment, the current resource allocation of the service mesh and the workload of the microservice chain are represented by a state of the RL model.

In an embodiment, a job is processed by at least one microservice and has an associated deadline.

In an embodiment, the reward is assigned if the job is completed before the associated deadline.

In an alternative embodiment, the reward is a function of a completion time of the job and the associated deadline.

In an embodiment, information representing historical resource allocation is collected for a period of time.

In an embodiment, the period of time is a function of an estimated value of the delay for allocating resources.

### BRIEF DESCRIPTION OF THE DRAWINGS

For better understanding of the present disclosure, and to show more readily how the invention may be carried into effect, reference will now be made, by way of example, to the following drawings, in which:

FIG. 1a shows an example of service mesh according to prior art;

FIG. 1b shows an example of microservice according to prior art;

FIG. 2 shows a flowchart illustrating a method performed by a device according to embodiments;

FIG. 3 shows a graph illustrating an example of elements of a reinforcement learning model implementing a method according to embodiments;

FIG. 4 shows a graph illustrating resource allocation as a function of time in a system operating according to embodiments;

FIG. 5a shows an example scenario where the present invention may be practiced according to embodiments;

FIG. 5b shows graphs illustrating resource allocation as a function of time in a system operating according to an embodiment of a method for scaling microservices in a service mesh;

FIG. 5c shows a graph illustrating reward values as a function of time received by an agent in a system operating according to embodiments;

FIG. 6 is a block diagram depicting a device in a first embodiment; and

FIG. 7 is a block diagram depicting a device in a second embodiment.

### DETAILED DESCRIPTION

Embodiments will be illustrated herein with reference to the accompanying drawings. These embodiments are provided by way of example so that this disclosure will be thorough and complete, and will fully convey the scope of the inventive concept to those skilled in the art.

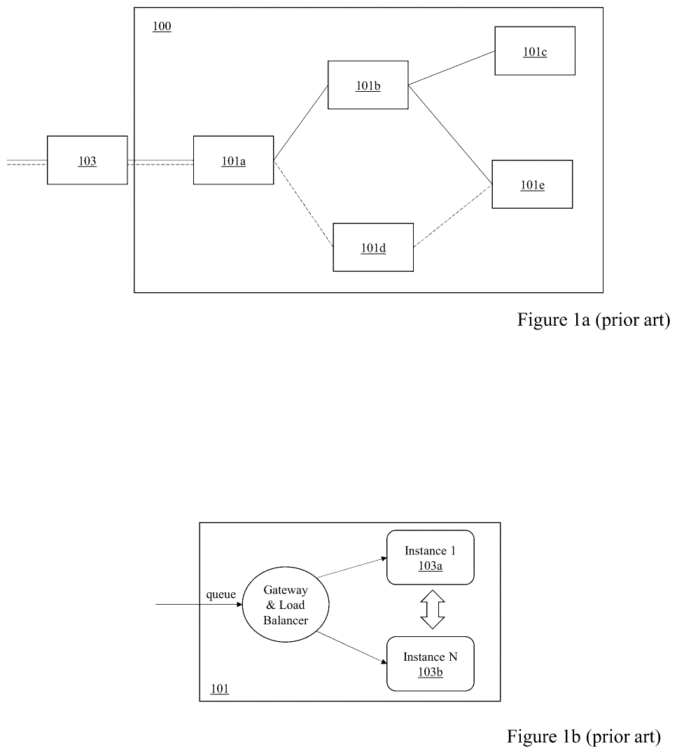

Microservice-based applications may experience a variation in workload that requires resource scaling. With reference to FIG. 1a, a sudden increase of the workload along a call graph composed of microservices 101a, 101d, and 101e, would require the corresponding microservices to scale out. If a microservice is scaled out only locally, i.e., using a local control loop, the local control loop would not take into account a delay due to a boot time for configuring and allocating the resources, and an effect of the scaling would be visible only when the workload has been processed by all the microservices in the call graph.

The solution to be disclosed, in its embodiments, uses a reinforcement learning, RL, model with a feedback signal to provide scaling of resources of the microservice-based application. In preferred embodiments, the reinforcement learning model learns an allocation of the resources for an input workload and the feedback signal takes into account the boot time for the resource allocation (scaling delay).

The present invention in its embodiments provides a desired Quality of Service, for example as specified in service-level agreements/service-level objectives SLAs/SLOs, while at the same time minimizing allocated resources. Further, the present invention in its embodiments provides benefits of improved responsiveness and faster scaling compared to local auto-scalers. The present invention in its embodiments provides a proactive approach to scaling resources that takes into account the delay due to the boot time for allocating the resources (scaling delay).

FIG. 1a shows an example scenario of a service mesh 100 of a microservice-based application. The term “service mesh” refers to a service that consists of a set of interconnected microservices. Traffic (i.e., jobs) is assumed to enter the system (i.e., the service mesh) via a common entry point 103, such as a gateway, load balancer, reverse proxy, or similar. In the common entry point 103, a workload, i.e., a specific type of jobs initiated externally by for example a user, is fingerprinted, i.e., a fingerprint is associated with the workload. A fingerprint is an identification of a type of workload and may comprise a combination of, but not limited to, information on point of origin of the workload (e.g., IP address, port, domain, application, user, company, etc.), header information (a format of the header may be HTTP for REST API), explicit meta information provided by a user. A workload may be for example a web service including a Virtual Network Function VNF, such as a VNF service chain or an artificial intelligence, AI, inference service, like streaming video with online face and identification detection.

A workload is processed by one or more microservices. Each workload may use a different and unique set of microservices. A workload may comprise one or more jobs. Each job that belongs to a same workload takes a same path through the microservice mesh, i.e., a same call graph or microservice chain. According to an embodiment, a job is processed by at least one microservice and has an associated deadline. A deadline is a point in time the job is expected to be completed.

Examples of workloads are video processing chain, virtual network processing, controlling of automation systems. Examples of microservices that process a workload may be encryption/decryption, video coding, AI inference, control system, etc. An example of job may be a user request.

FIG. 1a shows an example of two call graphs, i.e., a chain of microservices used for processing jobs of a workload. In the example scenario of FIG. 1a, call graph 1 is composed of four microservices (101a, 101b, 101c, 101e, connected by a full line in the figure), and call graph 2 is composed of three microservices (101a, 101d, and 101e, connected by a dashed line in the figure). Call graphs are typically unknown and data dependent, therefore information on the call graphs cannot be used to decide how to scale the microservices.

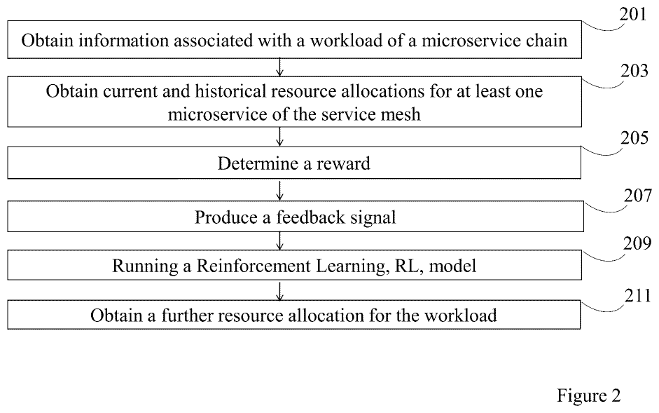

An example of microservice 101 is shown in FIG. 1b, wherein the microservice comprises one or more instances 103a, 103b, and a gateway and load balancer. The microservice 101 has a queue of jobs, wherein the queue has a finite capacity: if the queue is full, jobs are dropped. An instance 103a, 103b of a microservice is a virtual machine or a container and requires a certain amount of time to boot and configure. The gateway and load balancer manage how jobs are distributed to instances. FIG. 2 shows a method for scaling microservices in a service mesh 100. In one embodiment, the method may be carried out by a device 300, also called RL scheduler in the document. According to an embodiment, a workload is processed by an RL scheduler.

Referring to the method of FIG. 2, in step 201, the method comprises obtaining 201 information representing a workload of a microservice chain 101a, 101d, 101e, wherein the workload comprises at least one job. The RL scheduler 300 may obtain the information from microservices 101a, 101d, 101e of the microservice chain. The obtained information may include number of missed packets (either discarded or simply delayed and missed the deadline) and a scaling delay for a microservice, wherein the scaling delay is the delay for increasing resource allocation of the microservice. The microservice may keep statistics of values of missed packets and scaling delay, and send the statistics to the RL scheduler, for example periodically or when the RL scheduler requests them.

In step 203, the method comprises obtaining 203 information representing current and historical resource allocations of the service mesh 100. The RL scheduler 300 may obtain the current and historical resource allocations from the microservices 101a, 101d, 10e of the microservice chain.

In step 205, the method comprises determining 205 a reward.

In step 207, the method comprises producing 207 a feedback signal, wherein the feedback signal is indicative of the delay for increasing the resource allocation of the service mesh 100.

Information representing the workload, the current and historical resource allocations, the reward, and the feedback signal are used as input for running a RL model in step 209. According to an embodiment, the feedback signal may be used by the RL scheduler to determine a period of time for collecting the historical resource allocations of the service mesh 100.

The output of the RL model is a further resource allocation, obtained in step 211.

A resource allocation of a service mesh defines information on how resources (e.g., CPU, RAM, instances) of the microservices of the service mesh are utilized at a certain point in time. The resource allocation of a microservice may be based on one or more of: length of a queue of jobs for the microservice 101, 101a, information on a number of instances 103a, 103b used by the microservice 101, 101a for processing a workload and information on CPU usage and RAM usage. Data on historical resource allocation may be collected for a period of time. The period of time may be configured in an optional embodiment. According to an embodiment, the period of time may further be configured dynamically based on the scaling delay for allocating resources to the microservice. Other parameters that may be taken into account to configure the period of time are RL model behavior, available memory, required speed of the RL model training. Increasing the resource allocation to a microservice requires a certain delay (scaling delay) due to the boot time for allocating and configuring the resources. Therefore, there is a delay between the signal sent to increase the resource allocation and the actual allocation of new resources. In consequence, the effect of the increased resources is also delayed. In this document the terms “increasing resource allocation”, “reducing resource allocation” or similar refer to increasing the capacity of the resources or increasing the number or amount of resources allocated to certain tasks or reducing the same. The period of time wherein data on historical resource allocation to a microservice is collected may be a function of the delay estimated for allocating resources to the microservice. A shorter period of time would speed up the method and require less memory. On the other hand, a longer period of time would improve accuracy.

The resource allocation of one or more microservices may be increased or decreased in one of the following ways (the list below is not exhaustive)
the number of instances may be increased/decreased by creating/destroying containers,
CPU and RAM can be released/utilized.

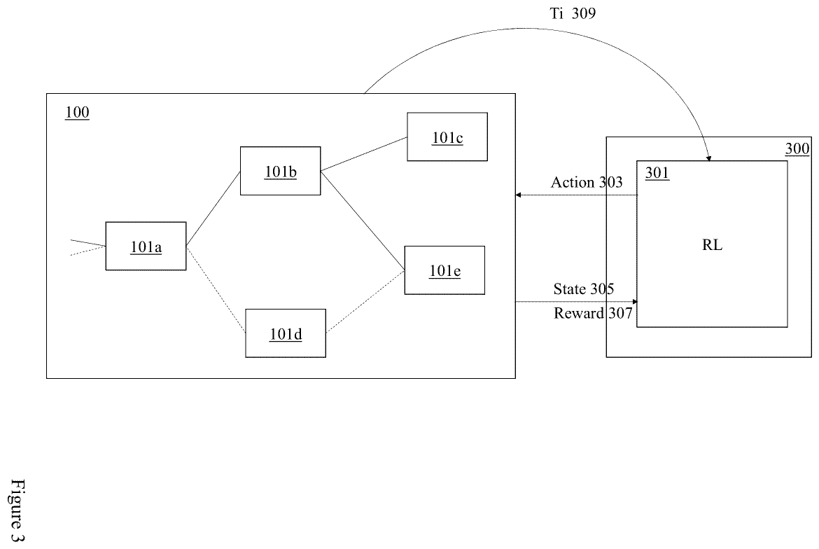

FIG. 3 shows a high-level view of elements of an RL model for performing a method according to embodiments. According to an embodiment, a RL scheduler 300 runs a RL algorithm 301, such as a Deep Deterministic Policy Gradient, DDPG, for an input workload. A purpose of the RL algorithm is for an agent to learn a policy that maximizes a reward, wherein a policy comprises suggested actions that the agent should take for every possible state.

The agent may be a RL scheduler 300 according to an embodiment, and perform some actions 303 in an environment, wherein the environment is represented with a state 305. According to an embodiment, the state 305 may be the current resource allocation of the service mesh 100, historical resource allocation and an information representing an input workload. A state 505 may be modified by an action 303 taken by the agent 300. According to an embodiment, actions 303 include increasing the pool of resources of the service mesh, decreasing the pool of resources, or doing nothing (i.e., resource allocation is not modified). The agent 300 may decide the action 303 to take based on two possible behaviors: exploitation and exploration. Exploitation comprises taking the decision assumed to be optimal with respect to data observed so far, i.e., historical resource allocation. Exploration comprises taking the decision that does not seem to be optimal, in order to discover a better decision, if there exists any. The agent 300 receives a reward 307, i.e., a feedback for performing an action 303 in a state 305.

The reward 307 that the agent receives may be indicative of the number of completed jobs and allocated resources of the service mesh 100, according to an embodiment. The reward may be a scalar value. According to an optional embodiment, the reward may also be a function of a completion time of a job of the workload and a deadline associated with the job. According to an optional embodiment, the reward is assigned to the agent if the job is completed before the associated deadline. According to an alternative embodiment, the reward is a value which decreases with the overrun, i.e., the more a job misses the deadline, the lower the value.

In case of a queue of jobs at a first microservice of a call graph, resource allocation of the microservice need to increase. In such a situation, the reward assigned to the agent will experience a delay (scaling delay). The delay is caused by a time needed to allocate and configure new resources for each microservice of the call graph. An effect of the increased capacity of the first microservice would not be visible until the job has been processed by all the microservices in the call graphs and therefore the reward is delayed. To address the problem of the delayed reward, a feedback signal T_i is produced, wherein T_i is indicative of a delay T associated with a microservice i to allocate and configure new resources of the microservice i. The delay of the microservice may be obtained by the RL scheduler from the microservice by measuring a time the microservice takes to allocate resources, i.e., from the point in time the agent 300 performs an action 303 (i.e., increasing resource allocation) until the point in time the resources are available. The microservice may keep statistics of values of the delay and send the statistics to the RL scheduler, for example periodically or when the RL scheduler requests them.

An example of a reward at a point in time t is a function of the length of a queue of jobs for the microservice. A first value may be assigned as reward if the length of the queue is lower than a threshold and a second value (lower than the first value) may be assigned as reward if the length of the queue is higher than the threshold. The threshold may be for example an average value of the length of the queue for a time period or any desired value.

An alternative example of a reward at a point in time t is “finished_jobs(t)*value(t)−running instances*cost”, wherein
“finished_jobs(t)” is the number of completed jobs in the service mesh at the point in time t,
“value(t)” is a scalar value different from zero if the job has been completed within a predefined deadline, zero otherwise (i.e., if the job has been completed after a predefined deadline), wherein the value of the scalar value different from zero is a design parameter; or “value(t)” may be the output of a sigmoid function.
“running instances” is the number of active instances used for processing the job, and
“cost” is a scalar value for example a price list at a cloud service provider that can be accessed programmatically using the provider's APIs. For on-premises, the cost may be a function of energy and required staff.

Using a mathematical formulation, the reward r_{Δ} at a point in time t is

$${r}_{Δ} ( t ) = {V}_{j o b} {f}_{N} ( t ) - {C}_{v m} {\sum }_{i = 1}^{N} [ {s}_{i} ( t - T ) + {\sum }_{τ = 1}^{T} max ( 0 , {s}_{i} ( t - τ + 1 ) - {s}_{i} ( t - τ ) ) ]$$

Wherein N is the number of microservices in the service mesh, V_{job}(t) corresponds to value(t) previously defined, f_{N} (t) is the number of finished jobs in the N microservices, and f_{N}(t)=min (sᵢ(t−T), qᵢ(t)), qᵢ(t) is the number of jobs in the queue Cᵥₘ is the cost per time for each instance, sᵢ(t) is the desired number of instances, sᵢ(t−T) is the current number of instances. Δ indicates that when a value of the reward is obtained, the value is added to a previously obtained value, since the RL model is continually learning from an input stream of data.

In case of more than one workload, the RL algorithms would generate one policy for each workload. Moreover, in case of more than one microservice, the scaling delay would be a vector of length equal to the number of microservices. The RL algorithm may be trained with one or more vectors of the scaling delay, thus generating one or more policies.

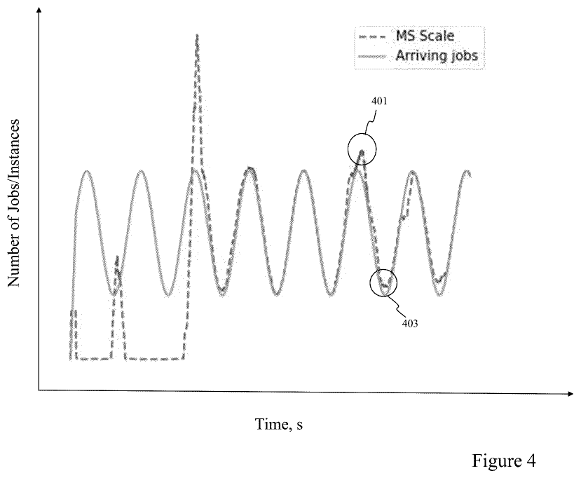

FIG. 4 shows an example of resource allocation in a system in which a service mesh operates in accordance with an embodiment of the method described earlier. Curves in FIG. 4 show values of an input workload, i.e., number of jobs, (full line) and values of allocated resources to a microservice, i.e., number of instances (dashed line) for a certain interval of time. A discrepancy between the two curves in an initial time period is due to the exploration behaviour of the RL scheduler 300. After the initial time period, the curve of the allocated resources follows the curve of the input workload because the RL scheduler 300 learned an improved (and preferably optimized) resource allocation for the workload. Some discrepancies between resource allocation and the actual workload are still visible, 401, 403 because the RL scheduler 300 still alternates, e.g., randomly, between the exploration behaviour and the exploitation behaviour.

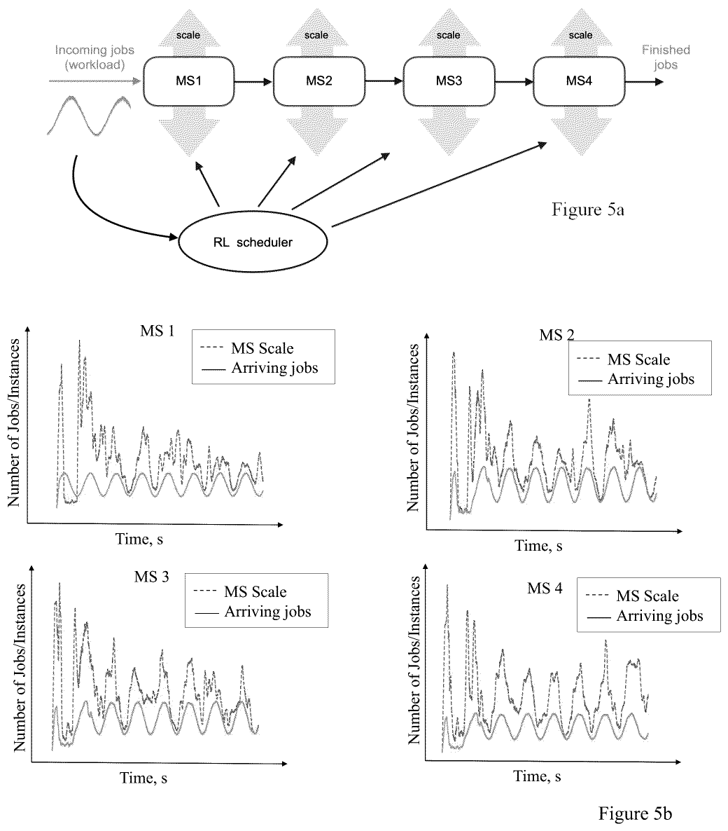

FIG. 5a shows an example scenario where the present invention may be practiced according to embodiments. FIG. 5a shows four microservices (MS1, MS2, MS3, and MS4) which are controlled by a RL scheduler 300. The RL scheduler 300 monitors an incoming workload and learns to scale the resource allocation simultaneously and globally for the microservices. The RL algorithm used in the experiments is DDPG. The RL scheduler learned how to simultaneously scale the four microservices based on the incoming workload. Results of the training are shown in FIG. 5b where each subplot shows two curves: one curve representing values of the input workload, i.e., number of input jobs, (full line) at the first microservice (MS1) and the other curve representing values of allocated resources, i.e., number of instances, (dashed line) in the corresponding microservice over a period of time. FIG. 5b shows how the values of the allocated resources, after an initial period of discrepancy due the exploration behaviour of the RL scheduler, follow the values of the input workload.

Using the same example scenario of FIG. 5a, performance of the DDPG based RL scheduler has been compared to a reactive workload scheduler, i.e., a Kubemetes-style scheduler. The Kubemetes-style scheduler is based on instance usage information. In particular in the simulations, the Kubemetes-style scheduler allocates new instances if a usage level of the resources of a microservice is above 80% of the total resources and frees up resources if the usage level is below 80%. A hysteresis function has been used to mimic the behavior of a real Kubemetes scheduler. FIG. 5c shows values of an accumulated reward for a certain time interval obtained performing a method according to embodiments (dashed line) and values of an accumulated reward for the time interval simulating a Kubemetes-style scheduler. FIG. 5c shows that a method according to embodiments outperforms the Kubemetes-style scheduler: the accumulated reward obtained performing the method according to embodiments has higher values than the accumulated reward obtained with the Kubemetes-style scheduler after an initial time period. In the initial time period, the RL agent according to embodiments takes actions based on the exploitation behaviour, resulting in a lower reward.

An example scenario in which the invention may be practiced is in relation to a real-time service such as streaming video with online face and identification detection, wherein microservices of a service mesh may be AI operations (such as inference, feature extraction, or a network functions, such as firewall, deep packet inspection) and a workload may be a user request. In this scenario a RL scheduler may be trained to generate a resource allocation for the varying workload due to an increasing number of users, according to the embodiments described in this document.

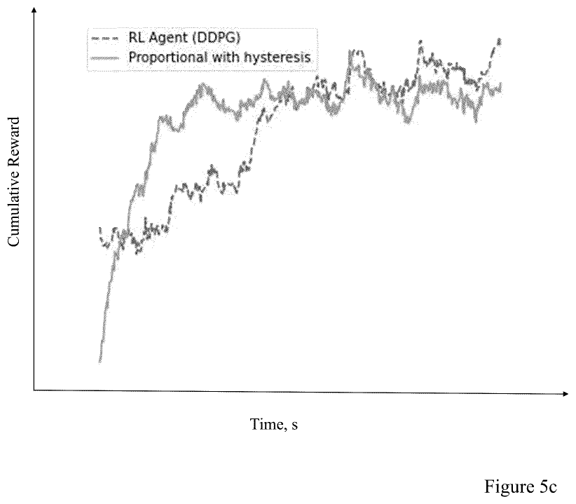

FIG. 6 is a block diagram illustrating one embodiment of a device 300 for scaling microservices in a service mesh, which implements the method described earlier. The device 300 comprises a processor, 601, a memory, 602, and communication circuitry, 603.

The memory, 602, contains instructions executable by the processor, 601, such that the device 300, in one embodiment is operative to obtain 201 information representing a workload of a microservice chain 101a, 101d, 101e, and current and historical resource allocations of the service mesh 100. The workload comprises at least one job in a preferred embodiment,

The device 300 is operative to determine 205 a reward, wherein the reward is a function of a number of completed jobs by microservices of the service mesh and current and historical resource allocations of the service mesh 100.

The device 300 is further operative to produce 207 a feedback signal, wherein the feedback signal is based on a delay for increasing a pool of resources of the service mesh 100.

The device 300 is operative to run 209 a RL model on the information representing workload and current and historical resource allocations, reward, and feedback signal; and obtain 211 a further resource allocation for the workload as an output of the RL model. In other words, the RL model receiving a workload as input, generates a resource allocation for the input workload so as to minimize the allocated resources of the service mesh 100.

The device, 300, may include a processing circuitry (one or more than one processor), 601, coupled to communication circuitry, 603, and to the memory 602. The device, 300, may comprise more than one communication circuitry. For simplicity and brevity only one communication circuitry, 603, has been illustrated in FIG. 6. By way of example, the communication circuitry, 603, the processor(s) 601, and the memory 602 may be connected in series as illustrated in FIG. 6. Alternatively, these components 603, 601 and 602 may be coupled to an internal bus system of the device, 300. The device 300 may use a representational state transfer application programming interface REST API to a microservice 101a-e. The device 300 and the microservice 101a-e may communicate with each other through a subscription protocol, such as message queuing telemetry transport MQTT protocol, or utilizing any one of a number of transfer protocols (e.g., frame relay, IP, transmission control protocol TCP, UDP, hypertext transfer protocol HTTP, HTTP/2) and Remote Procedure Call, RPC, protocols, such as gRPC, and ensuring security requirements by using transport layer security, TLS.

The memory 602 may include a Read-Only-Memory, ROM, e.g., a flash ROM, a Random Access Memory, RAM, e.g., a Dynamic RAM, DRAM, or Static RAM, SRAM, a mass storage, e.g., a hard disk or solid state disk, or the like.

The device 300 may be a router, gateway, or any device with computing, storage, and network connectivity to the service mesh 100, e.g., a COTS (commercial off-the-shelf) product, like a server.

The device 300 further comprises a computer program product 605 in the form of a computer readable storage medium 606, which in some embodiments may be implements as a memory 602.

The computer program product 605 comprises a computer program 605, which comprises computer program code loadable into the processor 601, wherein the computer program 604 comprises code adapted to cause the device 300 to perform the steps of the method described herein, when the computer program code is executed by the processor 601. In other words, the computer program 604 may be a software hosted by the device 300.

It is to be understood that the structures as illustrated in FIG. 6 are merely schematic and that the device, 300, may actually include further components which, for the sake of clarity, have not been illustrated, e.g., further interfaces or processors. Also, it is to be understood that the memory, 602, may include further program code for implementing other and/or known functionalities.

It is also to be understood that the device, 300, may be provided as a virtual apparatus. In one embodiment, the device, 300, may be provided in distributed resources, such as in cloud resources. When provided as virtual apparatus, it will be appreciated that the memory, 602, processing circuitry, 601, and communication circuitry, 603, may be provided as functional elements. The functional elements may be distributed in a logical network and not necessarily be directly physically connected. It is also to be understood that the device, 300, may be provided as a single-node device, or as a multi-node system.

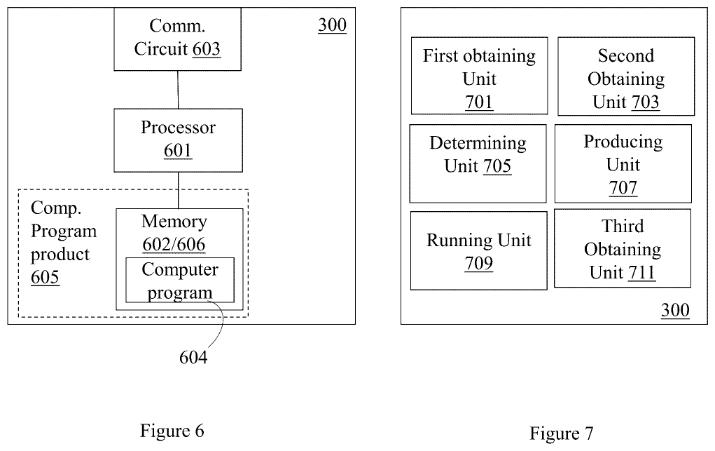

FIG. 7 schematically illustrates, in terms of a number of functional units, the components of a device 300 according to an embodiment. A first obtaining unit 701 and a second obtaining unit 703 are configured to obtain 201 information representing a workload of a microservice chain 101a, 101d, 101e and to obtain 203 current and historical resource allocations of the service mesh 100, respectively. Further, the device 300 comprises a determining unit 705 configured to determine 205 a reward and a producing unit 707 configured to produce 207 a feedback signal. The first and second obtaining unit 701, 703, the determining unit 705, and the producing unit 707 may be connected to a running unit 709: the information representing the workload, the current and historical resource allocations, the reward, and the feedback signal are inputs of a RL model that the running unit 709 is configured to run 209. The running unit 709 is connected to a third obtaining unit 711 configured to obtain a further resource allocation for the workload.

In general terms, each functional unit 701-711 may be implemented in hardware or in software. Preferably, one or more or all functional units 701-711 may be implemented by the processor 601, possibly in cooperation with the communications circuitry 603 and the computer readable storage medium 606 in the form of a memory 602. The processor 601 may thus be arranged to fetch from the computer readable storage medium 606 in the form of a memory 602 instructions as provided by a functional unit 701-711 and to execute these instructions, thereby performing any steps of the device 300 as disclosed herein.

1. A method for scaling microservices in a service mesh, the method comprising:
obtaining information representing a workload of a microservice chain, wherein the workload comprises at least one job;
obtaining information representing current and historical resource allocations of the service mesh,
determining a reward, wherein the reward is indicative of completed jobs and allocated resources of the service mesh;
producing a feedback signal, wherein the feedback signal is indicative of a delay for increasing the resource allocation of the service mesh;
running a Reinforcement Learning, RL, model on the information representing the workload, current and historical resource allocations, reward, and feedback signal;
obtaining a further resource allocation for the workload as an output of the RL model.

2. The method according to claim 1, wherein a resource allocation of the service mesh comprises a queue of jobs for at least one microservice and a number of instances for running the at least one microservice.

3. The method according to claim 1, wherein the current resource allocation of the service mesh and the workload of the microservice chain are represented by a state of the RL model.

4. The method according to claim 1, wherein a job is processed by at least one microservice and has an associated deadline.

5. The method according to claim 4, wherein the reward is assigned if the job is completed before the associated deadline.

6. The method according to claim 4, wherein the reward is a function of a completion time of the job and the associated deadline.

7. The method according to claim 1, wherein information representing historical resource allocation is collected for a period of time.

8. The method according to claim 1, wherein the period of time is a function of an estimated value of the delay for allocating resources.

9. A device for scaling microservices in a service mesh, the device comprising a processor and a memory, the memory having stored thereon instructions executable by the processor, wherein the instructions, when executed by the processor, cause the device to:
obtain information representing a workload of a microservice chain, wherein the workload comprises at least one job;
obtain information representing current and historical resource allocations of the service mesh,
determine a reward, wherein the reward is a function of completed jobs and allocated resources of the service mesh;
produce a feedback signal, wherein the feedback signal is based on a delay for increasing the resource allocation of the service mesh;
run a Reinforcement Learning, RL, model on the information representing the workload, current and historical resource allocations, reward, and feedback signal;
obtain a further resource allocation for the workload as an output of the RL model.

10. The device according to claim 9, wherein a resource allocation of the service mesh comprises a queue of jobs for at least one microservice and a number of instances for running the at least one microservice.

11. The device according to claim 9, wherein the current resource allocation of the service mesh and the workload of the microservice chain are a state of the RL model.

12. The device according to claim 9, wherein a job is processed by at least one microservice and has an associated deadline.

13. The device according to claim 12, wherein the reward is assigned if the job is completed before the associated deadline.

14. The device according to claim 12, wherein the reward is a function of a completion time of the job and the associated deadline.

15. The device according to claim 9, wherein information representing historical resource allocation is collected for a period of time.

16. The device according to claim 9, wherein the period of time is a function of an estimated value of the delay for allocating resources.

17. A computer program comprising instructions which, when run in a processing unit on a device, cause the device to:
obtain information representing a workload of a microservice chain, wherein the workload comprises at least one job;
obtain information representing current and historical resource allocations of the service mesh;
determine a reward, wherein the reward is a function of completed jobs and allocated resources of the service mesh;
produce a feedback signal, wherein the feedback signal is based on a delay for increasing the resource allocation of the service mesh;
run a Reinforcement Learning, RL, model on the information representing the workload, current and historical resource allocations, reward, and feedback signal;
obtain a further resource allocation for the workload as an output of the RL model.

18. A computer program product comprising a computer readable storage medium on which a computer program according to claim 17 is stored.
